(19) United States
(12) Patent Application Publication
(10) Pub. No.: US 2015/0060582 A1
(43) Pub. Date: Mar. 5, 2015

(54) METHOD AND APPARATUS FOR SEPARATING PARTICULATE MATTER

(71) Applicant: ELECTRICITY GENERATION AND RETAIL CORPORATION, Perth, Western Australia (AU)

(72) Inventors: Rodney Truce, East Granville (AU); Jian Ning Zhu, Port Augusta West (AU); Francis Hugh Kidman, Allanson (AU)

(21) Appl. No.: 14/383,317

(22) PCT Filed: Mar. 6, 2013
(86) PCT No.: PCT/AU2013/000212

§ 371 Date: Sep. 5, 2014

(30) Foreign Application Priority Data
Mar. 7, 2012 (AU) 2012900889

(51) Int. Cl. B02C 23/22; B07B 9/00; B07B 4/08; B02C 23/12; B02C 23/14

(52) U.S. Cl. CPC B02C 23/22; B02C 23/12; B02C 23/14; B07B 4/08; B07B 9/00
USPC 241/38; 209/474; 209/44

(57) ABSTRACT

A separation apparatus for separating minerals or other particulate matter, including a housing, a particulate inlet, a fluid inlet and an outlet. The separation apparatus separates the minerals or other particulate matter, based on density. This is achieved by ingressing a fluid into the fluid inlet to create appropriate fluidization of the particulate matter within the housing. Low density material may typically be extracted from an upper end of the housing, whilst higher density material may be typically extracted from a lower end of the housing. The invention is particularly useful for separating minerals such as coal from impurities such as silica and pyrites.

### BACKGROUND OF THE INVENTION

The present invention relates to an apparatus and method for separating particulate matter. In particular, the present invention relates to such an apparatus and method which is useful for separating minerals on the basis of density.

In a preferred, but not limiting embodiment, the present invention relates to specific processes to remove mineral matter from the re-circulating matter within a grinding mill on the basis of density. The specific processes include an initial particle selection based on size using a screening process to select particulate matter that has been ground to a size where the composition is close to homogenous. A second process is then used to separate the low density material from the high density material. The low density material may be fed back into the mill while the high density component is removed or the low density material may be removed while the high density component is fed back into the mill.

### DESCRIPTION OF THE PRIOR ART

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

A typical vertical spindle mill [80] for use in grinding coal, limestone or some other material is shown in FIG. 1. Feed stock is fed down the centre of the mill [81] to the grinding section [82] where it is crushed into smaller particles. These particles are normally air conveyed [83] within the mill to a classifier [84] where the larger particles [86] are separated from the fine particles [87] and returned to the grinding process [82] for further grinding. This results in a recirculating load of large particles that are carried from the grinding section [82] of the mill to the classification section [84] then returned to the grinding section [82]. The grinding is normally performed by wheels [85] or balls lower in the mill and a gas, normally air, is blown [88] over the grinding section [82] so as to carry the ground material to the classifier [84], normally located at the top of the mill. The larger particles rejected in the classifier [84] are normally returned to the lower grinding section [82] via a reject chute [86]. A typical example of a vertical spindle mill is shown in FIG. 1 and the resulting large particle recirculation process is depicted in FIG. 2. FIG. 3 shows further detail of a typical vertical spindle mill.

This same process takes place in a typical ball mill [100], examples of which are shown in FIGS. 5 and 6. In a ball mill the feed stock [81] is fed into the end of a rotating drum [90]. Large balls [95] crush the feed stock into smaller particles. The particles are air conveyed [93] to a classifier [94] where the larger particles [96] are separated from the fine particles [97] and returned to the grinding process [82] for further grinding. Again in the ball mill a gas is blown [98] over the grinding section [82] so as to carry the ground material to the classifier [94], which in this case is located separate to the grinder. The larger particles rejected in the classifier [94] are returned to the grinding section [82] via a reject chute [96].

The raw feed stock that is initially fed into the mill [81] will normally be composed of a conglomerate with different mineral impurities bound together by another primary mineral. Typical examples of this are coal and limestone where various impurity components may contain minerals, such as silica (sand), pyrites (iron), calcium and/or alumina (in the clay component), that are embedded in primary mineral in the form particles or small lumps of the individual impurities. In the case of coal the primary mineral matter is carbon whereas in the case of limestone the primary mineral matter is calcium carbonate. The milling process crushes the feed stock releasing any particles that formed the conglomerates within the primary mineral. Thus in the case of coal, particles of sand, iron and clay will be generated in addition to particles of carbon.

Separation of mineral components can be performed based on different physical or chemical properties, for example electrical resistivity or solubility. In the case of coal, if it is required to separate the carbon from the other low density minerals, such as alumina, calcium or clay material, an electrostatic separator may be used to separate the low resistivity carbon from the highly resistive alumina or calcium material. Electrostatic separators are also known to be used in the sand mining industry to separate out the valuable minerals that could be added to the current mineral removal process to increase the degree of separation of either the low or high density material. Further separation based on solubility is another option for additional processing of the low or high density material. Washing the extracted material will remove the soluble components, which can later be recovered by evaporating the water if required.

All these prior art separation processes seek to remove impurities or the like, such that an improved concentration of the desired mineral is effectively retrieved.

### SUMMARY OF THE INVENTION

The present invention seeks to provide an improved, or at least an alternative to known, separation apparatus and process for separating particulate matter.

The present invention also seeks to provide a separation apparatus and separation process, which performs separation of mineral or other particulate matter on the basis of density.

In one broad form, the present invention provides a separation apparatus for separating particulate matter, including:
a housing;
a particulate inlet, adapted to ingress said particulate matter into said housing;
a fluid inlet, adapted to ingress a fluid into said housing; and
an outlet, adapted to egress particulate matter of a predetermined density from said housing.

Preferably, said fluid inlet is adapted to ingress said particulate matter in a lower portion of said housing.

Also preferably, said outlet is adapted to egress particulate matter of a predetermined density from an upper portion of said housing.

Also preferably, said outlet is adapted to egress particulate matter of a predetermined density from a lower portion of said housing.

Also preferably, said outlet is adapted to egress particulate matter of a predetermined density from an upper portion of said housing and said apparatus further includes a second outlet which is adapted to egress particulate matter of a second predetermined density from a lower portion of said housing.

Also preferably, said particulate inlet includes at least one size separation screen.

Also preferably, said housing is sectionalized.

Also preferably, said housing includes at least one distribution screen adapted to aid distribution of a fluid flowing through said screen.

Also preferably, said apparatus includes a plurality of fluid inlets.

Also preferably, said fluid inlet is located below a perforated plate that extends across the housing.

In a further broad form, the present invention provides a multi-stage separation device for separating particulate matter, including at least two said separation apparatus as hereinbefore defined, wherein said outlet of a first separation apparatus is adapted to feed particulate matter to said particulate inlet of a second separation apparatus.

Preferably, a size separation screen is located between said outlet of first separation device and said particulate inlet of second separation device.

In a further broad form, the present invention provides a method for separating particulate matter using a separation apparatus including:
a housing
a particulate inlet, adapted to ingress of said particulate matter into said housing
a fluid inlet, adapted to ingress a fluid into said housing
an outlet adapted to egress particulate matter of a predetermined density from said housing;
the method including the steps of:
   ingressing particulate matter into said housing via said particulate inlet,
   ingressing said fluid into said housing via said fluid inlet, and
   egressing particulate matter of a predetermined density from said housing via said outlet.

In a further broad form, the present invention provides a separation apparatus for separating particulate matter, adapted for use with a grinding or milling device, the separation apparatus including:
a housing;
a particulate inlet, adapted to ingress said particulate matter into said housing;
a fluid inlet, adapted to ingress a fluid into said housing; and
an outlet adapted to egress particulate matter of a predetermined density from said housing.

Preferably, said fluid inlet is adapted to ingress said particulate matter in a lower portion of said housing.

Also preferably, said outlet is adapted to egress particulate matter of a predetermined density from an upper portion of said housing.

Also preferably, said outlet is adapted to egress particulate matter of a predetermined density from a lower portion of said housing.

Also preferably, said outlet is adapted to egress of particulate matter of a predetermined density from an upper portion of said housing and said apparatus further includes a second outlet which is adapted to egress particulate matter of a second predetermined density from a lower portion of said housing.

Also preferably, said particulate inlet includes at least one size separation screen.

Also preferably, the separation apparatus is sectionalized.

Also preferably, said apparatus housing includes at least one distribution screen adapted to aid distribution of a fluid flowing through said screen.

Also preferably, said apparatus includes a plurality of fluid inlets.

Also preferably, said fluid inlet is located below a perforated plate that extends across the housing.

In a further broad form, the present invention provides a multi-stage separation device for separating particulate matter, including at least two separation apparatus as hereinbefore defined, wherein said outlet of first separation apparatus is adapted to feed particulate matter to said particulate inlet of second separation apparatus.

Preferably, a size separation screen is located between said outlet of first separation device and said particulate inlet of second separation device.

Also preferably, the device or apparatus is installed in a vertical spindle mill.

In a further broad form, the present invention provides a method for separating particulate matter in a grinding or milling device using a separation apparatus including:
a housing
a particulate inlet, adapted to ingress of said particulate matter into said housing a fluid inlet, adapted to ingress a fluid into said housing
an outlet adapted to egress particulate matter of a predetermined density from said housing;
the method including the steps of:
   ingressing particulate matter into said housing via said particulate inlet,
   ingressing a fluid into said housing via said fluid inlet, and
   egressing particulate matter of a predetermined density from said housing via said outlet.

### BRIEF DESCRIPTION OF THE DRAWINGS

The present invention will become more fully understood from the following detailed description of preferred but non limiting embodiments thereof, described in connection with the accompanying drawings, wherein:

FIG. 1 is a section view of a prior art typical vertical spindle mill;

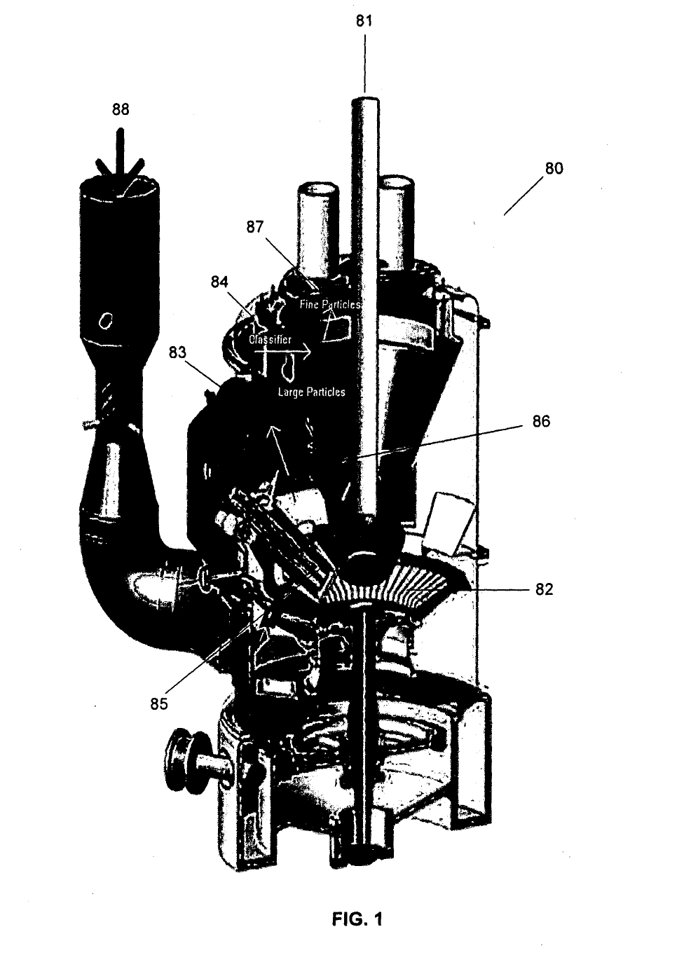

FIG. 2 is a prior art vertical spindle mill depicting the large particle recirculation process;

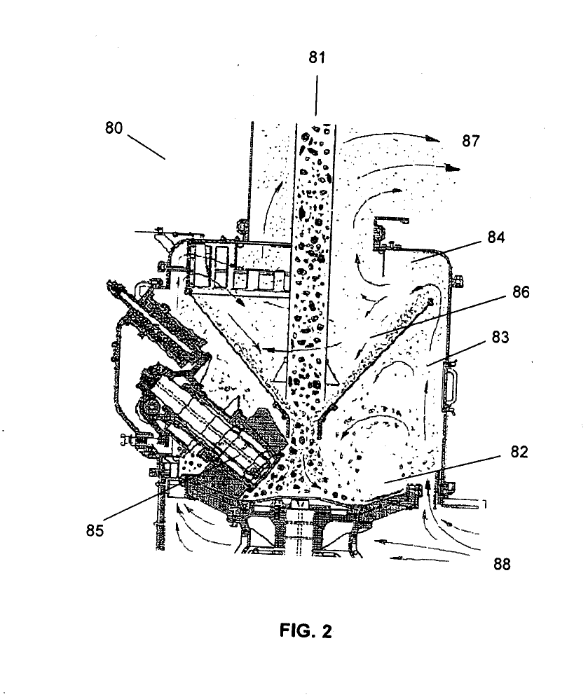

FIG. 3 is a prior art vertical spindle mill;

FIG. 4 shows the invention installed in a vertical spindle mill, including the fluidizing air inlet and particulate outlet;

FIG. 5 is a prior art typical ball mill;

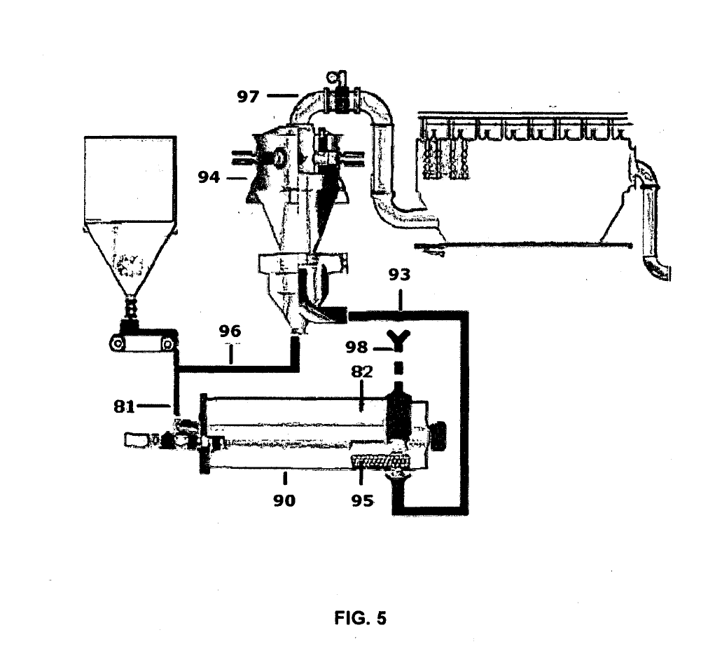

FIG. 6 is a prior art typical ball mill depicting the flow of various particles;

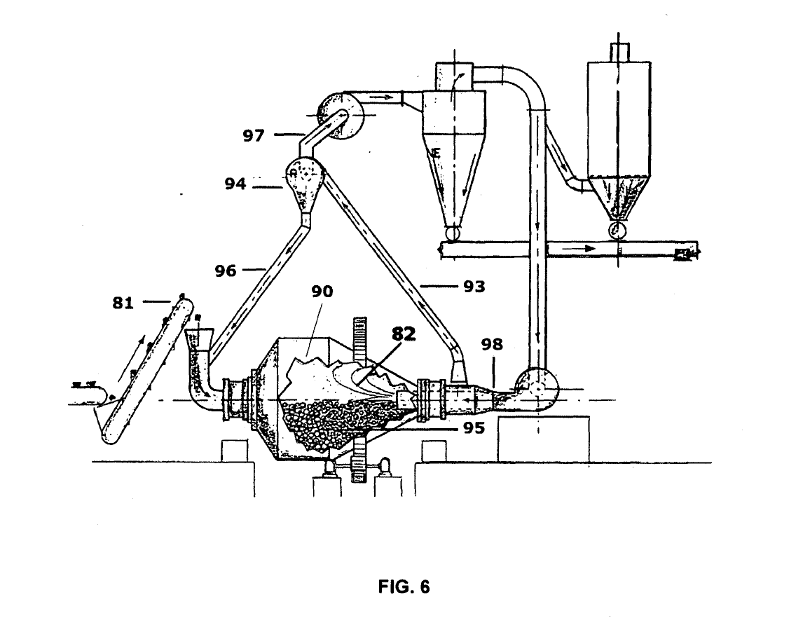

FIG. 7 shows the invention installed in a ball mill;

FIG. 8 is a two stage embodiment of the invention including multiple distribution screens, size separation screens above the particulate inlet and a size separation screen between the stages;

FIG. 9 is a top view of a sectionalized embodiment of the invention;

FIG. 10 is a multi-stage embodiment including multiple air supplies, multiple distribution screens, and size separation screens above the particulate inlet as well as between the stages; and,

FIG. 11 is a single stage embodiment including a fluid distribution box and perforated plate, multiple distribution screens and separation screens above the particulate inlet.

### DETAILED DESCRIPTION OF THE PREFERRED EMBODIMENT

Throughout the drawings, like numerals will be used to identify similar features, except where expressly otherwise indicated.

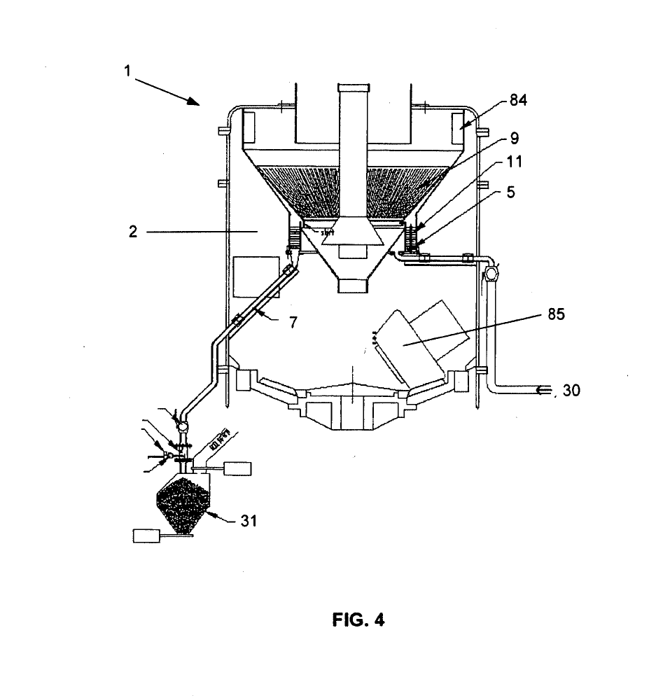

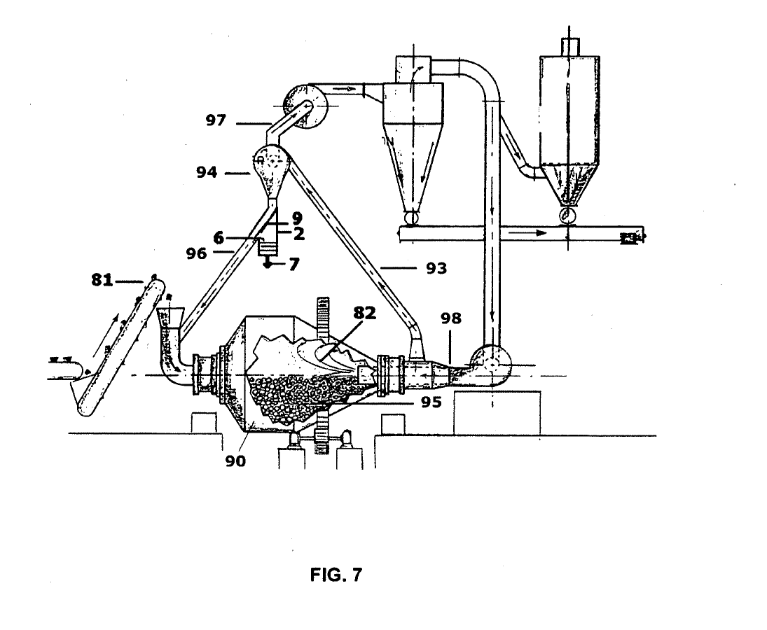

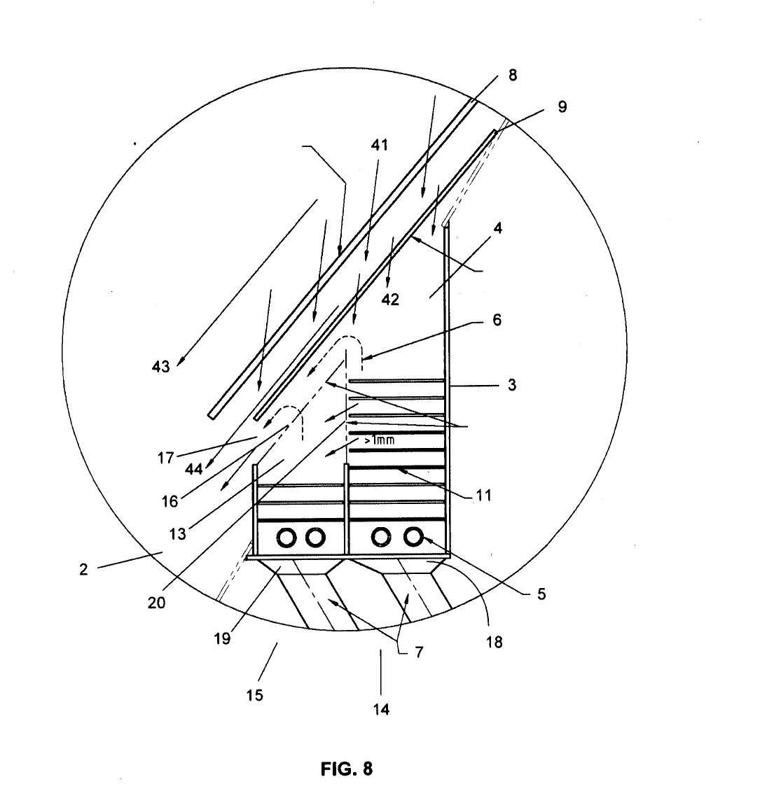

FIG. 4 shows a preferred embodiment of the invention installed in a vertical spindle mill [1] and FIG. 7 shows a preferred embodiment installed in a ball mill [110]. The separation apparatus [2] is shown in detail in FIG. 8. It includes a housing [3], a particulate inlet [4], a fluid inlet [5] and an outlet [6]. The housing [3] would typically be made from steel, but may be any other suitable material or composite. Particulate matter, typically but not limited to, coal, limestone or other minerals, enters the apparatus [2] via particulate inlet [4]. A fluid, usually air, but which may be any other fluid with appropriate properties and does not react with the particulate matter, enters the apparatus [2] via fluid inlet [5]. The fluid may be pressurised, and, as will be understood by persons skilled in the art, the optimal pressure may be determined based on the densities of the particulate matter, the volume of the housing, the target material to be separated and other factors, such that appropriate mixing or fluidization occurs between the particulate matter and the fluid. Particulate matter of a predetermined density exits the apparatus [2] via outlet [6]. For example, if the primary material is coal, high density particles such as silica and pyrites may be collected while low density particles such as carbon exit the apparatus.

In the preferred embodiment the fluid inlet [5] is located such that fluid enters into a lower portion of the apparatus housing [3]. This allows the fluid to flow up through the particulate matter, causing it to become fluidized. Low density material is then able to settle towards the top of the housing [3] while high density material moves towards the bottom.

The outlet [6] is located such that particulate matter of a predetermined density exits from an upper portion of the apparatus housing [3]. Alternatively, the outlet [7] can be located such that particulate matter of a predetermined density exits from a lower portion of the apparatus housing [3]. As in the embodiment shown, the apparatus [2] may include both an upper outlet [6] and a lower outlet [7]. FIG. 4 shows an embodiment with an upper outlet [6] that allows material to return to the grinding process [82] and a lower outlet [7] that connects to a mill rejects hopper [31]. This material may be completely removed from the grinding process or undergo further processing.

The particulate inlet [4] may include at least one size separation screen [8]. In the embodiment shown a second separation screen [9] is also present. In the case of coal, the first separation screen [8] may allow particles below about 10 mm to pass through [41] with the second screen [9] allowing particles below about 3 mm to pass through [42]. These are only typical values, with the sizes to be separated being determined by the particular material composition being sorted. Material too large for the first screen [43] or too large for the second screen [44] is typically returned to the grinding process [82].

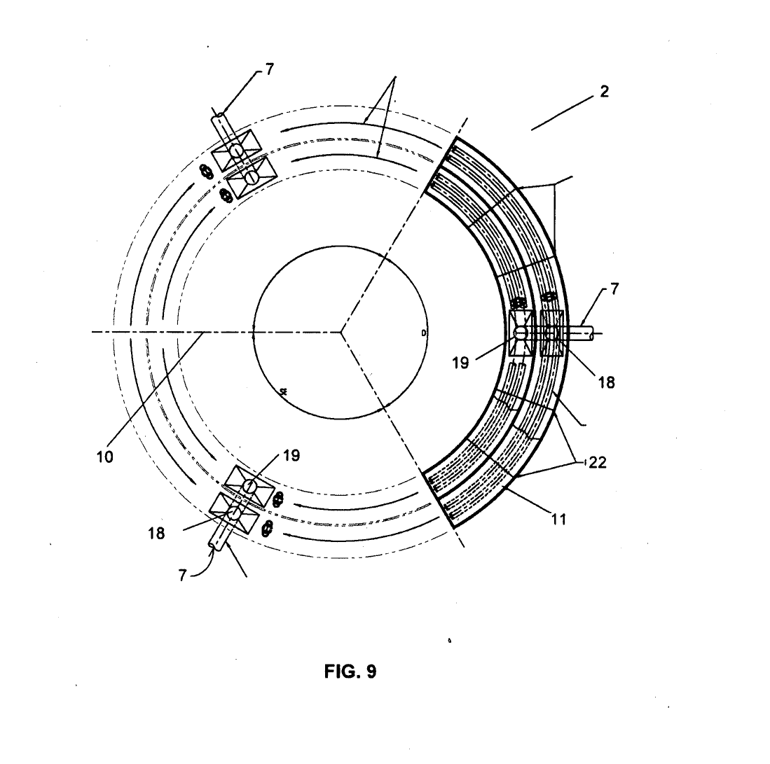

FIG. 9 shows an embodiment of a separation apparatus [2] that has been sectionalized using solid splitter plates [10] and perforated splitter plates [22]. Sectionalizing the separation apparatus [2] using solid splitter plates [10] improves the effectiveness by limiting the volume of material being fluidized. Each section will have a separate outlet [7] and the smaller size improves the fluid distribution and prevents accumulation of high or low density material at the ends of the apparatus.

The preferred embodiment also includes fluidized bed bubble screens, or distribution screens [11], that aid the distribution of the fluid flow across the housing [3]. Consistent fluid flow across the apparatus ensures that the density separation is more effective, as higher flows in particular areas will cause higher density particles to be carried to the top.

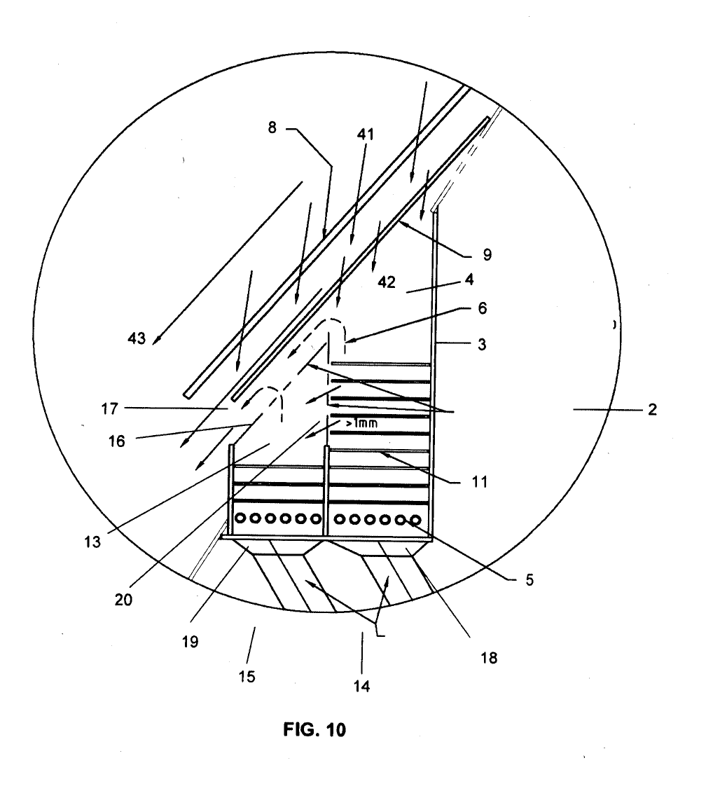

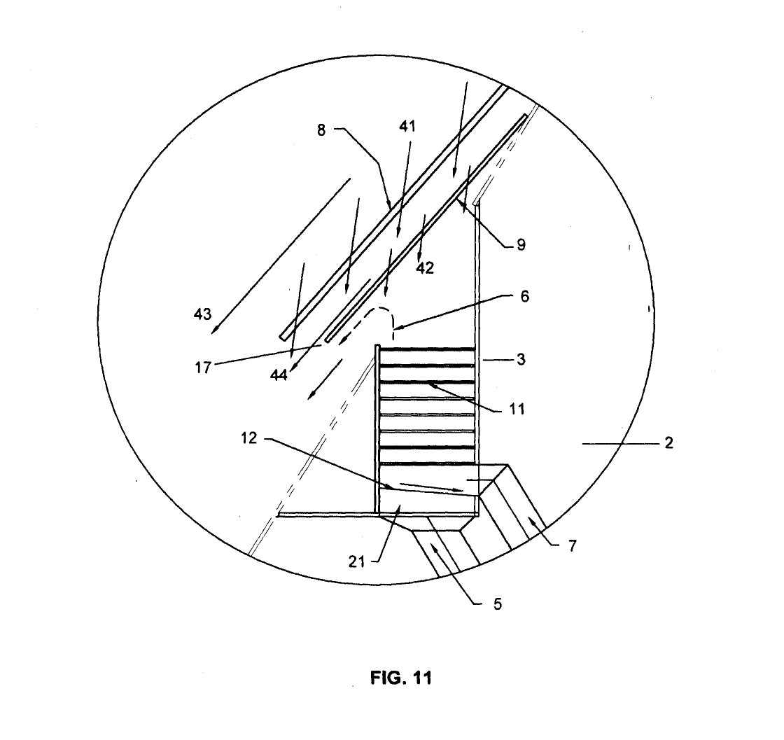

FIG. 10 shows an embodiment with numerous fluid inlets [5]. This is another feature aimed at improving distribution of the fluid in the housing [3]. Another method of achieving well distributed flow is shown in FIG. 11 where the fluid inlet [5] is located below a perforated plate [12], creating an air distribution box [21]. This perforated plate ensures the fluid enters the section of the housing [5] containing the particulate matter as evenly as possible. This plate may also be sloped towards an outlet [7] to aid in the removal of high density material.

FIG. 8 and FIG. 10 show embodiments that include two stages. In each case the particulate outlet [6] of the first stage [14] feeds into the particulate inlet [13] of the second stage [15]. In these embodiments a separation screen [20] is located between the outlet [6] of the first stage [14] and the particulate inlet [13] of the second stage [15]. This allows particles of a low density but still above a certain size to be returned to the grinding process [82], while only particles of a low density and below a certain size to enter the second stage [15].

The process in the current invention may be applied to any grinding process where conglomerates of varying density mineral matter are being ground and impurities of either a higher density or a lower density are to be removed. In addition to the utility industry, where coal is ground, and the cement industry, where limestone is ground, there are many other applications in the manufacturing and mineral processing industry where high density or low density impurities may be removed using this process.

The grinding process breaks up the conglomerate releasing these particles of non-primary mineral matter, the impurities to be removed. The screening process that may form part of the current invention is designed to stop particles above a pre-determined size from entering the density separator, so that the particles entering the density separator are broken up by the grinding process to the extent that they are no longer conglomerates of different mineral particles bound by the primary mineral. Particles below a predetermined size will be primarily composed of the primary mineral matter or the various impurities that may be targeted for removal. For example in the case of coal, the primary minerals targeted for removal are silica (sand) and pyrites (iron), which are higher in density than the primary mineral matter, carbon. The size of the particles that are allowed to enter the density separation process will be determined by sampling the circulating particle load in the mill and assign the particle size below which the targeted impurities are concentrated in individual particles containing little of the primary mineral.

In the embodiment shown in FIG. 8 the physical separation process that limits the size of the material entering the density separator is a two stage process. Initial separation uses a primary screen [8] that may be formed from a slotted steel sheet (5 mm to 10 mm slots) to separate the large particles, which form the main component of the recirculating material. This is followed by a screen [9] that may be made from parallel wedge wire members separated by 1 mm to 3 mm at the entrance [4] to the density separator [2] to prevent all but the pre-determined target particle size (normally between 1 mm and 3 mm) from entering the density separator [2].

The screening process may also include a range of physical separation processes including:

Screens composed of spaced parallel members that the material flows over thereby allowing the smaller particles to fall through while the larger particles are prevented from entering the space below by the parallel members.

Screens in the farm of a sieve using multiple crossing members with a set separation in the form of a mesh or a solid plate with multiple holes of a set size to prevent particles larger than the gap or hole size from entering the space beyond the screen.

The density separator [3] may be a vertical container with the selected small particles entering at the top [4] and the high density particles exit [7] from the bottom, normally out of the separator for collection or further processing or alternatively for return to the milling process. The density separator [2] uses a gas, normally air, to fluidize the particles and carry the low density particles out [6] at the top, normally through the screen into the rejects chute [17] or alternatively out of the separator for collection or further processing. The fluidizing gas enters the density separator from one or more distribution manifolds [5] located at the bottom of the vertical container [3]. Within the density separator [2] are a series of gas distribution members [11], normally horizontal mesh screens, located above the gas inlet manifold [5] to ensure the fluidizing gas is distributed equally across the density separation [3] and throughout the material contained therein. This ensures all the selected small particles are affected by the fluidizing gas.

There are therefore two primary forces acting on the particles in the density separator [2], gravitational forces, which are proportional to mass, acting in the downward direction and viscous forces, which are a function of surface area and the upward flow of the fluidizing gas, acting in an upward direction. As a result, high density particles with a high mass to surface area ratio will work their way to the bottom of the density separation container [3] while the low density, low mass to surface area ratio, will move up to the top of the fluidized particles. The degree of separation can be controlled by the fluidizing gas flow with increasing gas flow carrying more dense particles to the top of the density separator [2]. Thus the high density particles would be removed or returned to the mill from outlet [7] at the bottom of the density separator and the low density particles would be removed or returned to the mill from outlet [6] at the top of the density separator [2].

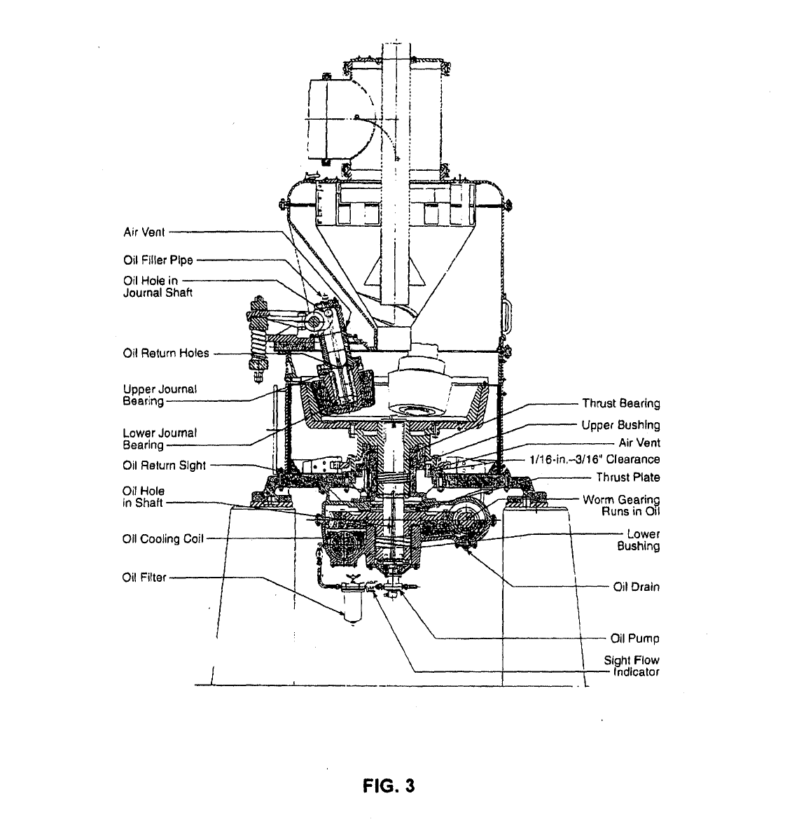

In the coal milling application, the low density material at the top of the density separation container would normally be returned to the mill but could be further processed to remove other minerals. An electrostatic separator could be used to separate the low resistivity carbon particles from the much higher resistivity calcium or alumina particles. Thus it is possible to separate the selected particulate into three components, high density material, primarily comprising of silica and pyrites, the low density mineral matter, normally existing as clay containing calcium and alumina minerals, and the low resistivity, low density carbon. This would allow the removal of most of the mineral matter impurities, which are not combustible and forms the ash residue that exits the combustion process, from the ground coal, which is the primary combustion material. These mineral matter impurities also contains most of the pollutants generated by the combustion process including particulate matter, sulfur, heavy metals and halogens such as chlorine and fluorine. FIG. 4 shows a typical example of the implementation of this dense mineral removal system [2] on a vertical spindle coal mill [1]. FIG. 3 is the vertical spindle mill without the dense mineral removal system and FIG. 4 shows the general arrangement for installing the dense mineral removal system in the lower section of the mill.

One of the problems with this density separator process is that it is particle size dependent since the mass and hence gravitational force is proportional to the particle volume, the cube of the particle diameter, and the viscous force is a function of surface area, the square of the particle size. So long as all particles in the density separator are about the same size this is not a significant, problem but large size variation will result in smaller dense particles being carried to the top of the density separator if the fluidizing gas flow is high or the larger low density particles moving to the bottom of the density separator if the fluidizing flow is low. To overcome this problem it is also possible to have multiple stage density separators. The first stage [14] would use a higher fluidizing gas flow to separate the larger particles, with the large high density particles being removed [18] from the bottom of the separator, the smaller particles being allowed into a second density separator [15] from the top of the first stage [20] and the larger low density [6] being removed or returned to the milling process. This would be achieved by having a screen [16] separating the two separators that only allowed smaller particles to pass into the second density separator [15]. The second density separator [15] would only act on the smaller particles and would have a lower gas flow. This lower fluidizing gas flow would carry the small low density particles to the top of the second stage density separator and allow the denser small particles to be removed [19] from the bottom of the separator.

A typical coal mill application may allow particles less than three millimetres into the first stage density separator [14] but restrict access to the second stage density separator [15] to particles less than one millimetre. FIG. 8 shows a typical example of the implementation of this dense mineral removal system [2] using a two stage density separator on a vertical spindle coal mill.

The more even the gas flow distribution is the more effective the density separation. Higher flows through sections of the particulate will cause higher density material to be carried to the top of the density separator while lower flows will allow less dense material to settle to the bottom. It is therefore very important to ensure the gas is well distributed when it is injected [5] at the bottom of the density separator and continues to flow evenly through the particulate bed so that the gas flow exits evenly at the surface of the particulate bed. The fluidized bed bubble screens, or distribution screens [11], shown in FIG. 8 will help maintain even gas flow distribution through the fluidized bed of particulate material.

Sectionalizing the density separator using solid or perforated splitter plates [10] to limit the volume of material fluidized, thereby improving the effectiveness of the fluidizing gas and the take-off of the more dense material. Sectionalizing will prevent the larger or finer particles from accumulating at the ends of the density separator thereby limiting the effectiveness of the separation process. Each section will have a separate high dense material removal system [7] at the bottom and a low density removal system [6] at the top, thereby enhancing the dense material removal and the fluidization of the material in the density separator. Limiting the size of the fluidized bed by sectionalizing the density separator will improve distribution of the flow of the fluidizing gas through the solid particulate and provide a more consistent separation. The provision of multiple take-off points [7] at the bottom of the density separator will increase the dense material removal efficiency particularly if it is sloped towards a take-off nozzle [18]. This arrangement is shown in FIG. 9.

The use of multiple fluidizing gas manifolds [5] at the bottom of the density separator to improve the distribution of the fluidizing gas and thereby enhance the fluidization of the material in the density separator will also improve the separator efficiency by improving the evenness of the gas flow distribution in the particulate. The best way to achieve this is to incorporate a gas distribution box [21] at the bottom of each section with multiple holes in the top [12], which is the bottom of the density separator, to ensure the flow is distributed evenly into the bottom of the particle bed. This arrangement is depicted in FIG. 10 with multiple fluidizing gas manifolds [5] and in FIG. 11 with a gas distribution box [21] beneath the bottom of the density separator.

Removal of the dense minerals in the coal milling process on pulverized fired boilers has many benefits including:

Reduced pollution from particulates, SO₂, SO₃, Hg, heavy metals and other Hazardous Air Pollutants (HAPS).

Reduced erosion, particularly from the silica component, in the mill, fuel pipes and the burners.

Reduced slagging in the boiler due to the reduced iron.

Reduced fouling in the rear of the boiler due to reduced particulate load.

Reduced maintenance and downtime due to wear issues in the mill.

Increased mill throughput due to increased milling efficiency.

The ability to burn lower quality coal with higher mineral matter content.

Many other benefits would result from implementing this process on other milling applications such as in the cement process. Other processes may be separating highly combustible or reactive material that requires an inert gas, such as Nitrogen, to fluidize the particulate material to prevent a reaction (oxidation) with the particulate as would occur if air were used.

The mineral separation process described can be enhanced by a range of additional separation processes, as in the examples above, to provide minerals with selected physical and/or chemical characteristics. This provides the bases of a mechanism for extracting specific minerals from a milling process with a conglomerate as the primary feed to the mill.

It will be appreciated by persons skilled in the art, that numerous variations and modifications may be made to the specific embodiments of the invention which have been hereinbefore described. All such variations and modifications should be considered to fall within the scope of the invention as hereafter claimed.

1. A separation apparatus for separating particulate matter, including:
a housing;
a particulate inlet, adapted to ingress said particulate matter into said housing;
a fluid inlet, adapted to ingress a fluid into said housing; and
an outlet, adapted to egress particulate matter of a predetermined density from said housing.

2. A separation apparatus as claimed in claim 1, wherein said fluid inlet is adapted to ingress said particulate matter in a lower portion of said housing.

3. A separation apparatus as claimed in claims 1 or 2, wherein said outlet is adapted to egress particulate matter of a predetermined density from an upper portion of said housing.

4. A separation apparatus as claimed in claims 1 or 2, wherein said outlet is adapted to egress particulate matter of a predetermined density from a lower portion of said housing.

5. A separation apparatus as claimed in claim 1 or 2, wherein said outlet is adapted to egress particulate matter of a predetermined density from an upper portion of said housing and said apparatus further includes a second outlet which is adapted to egress particulate matter of a second predetermined density from a lower portion of said housing.

6. A separation apparatus as claimed in any of claims 1 to 5, wherein said particulate inlet includes at least one size separation screen.

7. A separation apparatus as claimed in any of claims 1 to 6, wherein said housing is sectionalized.

8. A separation apparatus as claimed in any of claims 1 to 7, wherein said housing includes at least one distribution screen adapted to aid distribution of a fluid flowing through said screen.

9. A separation apparatus as claimed in any of claims 1 to 8, wherein said apparatus includes a plurality of fluid inlets.

10. A separation apparatus as claimed in any of claims 1 to 9, wherein said fluid inlet is located below a perforated plate that extends across the housing.

11. A multi-stage separation device for separating particulate matter, including at least two said separation apparatus as described in any of claims 1 to 10, wherein said outlet of a first separation apparatus is adapted to feed particulate matter to said particulate inlet of a second separation apparatus.

12. A multi-stage separation device as claimed in claim 11, wherein a size separation screen is located between said outlet of first separation device and said particulate inlet of second separation device.

13. A method for separating particulate matter using a separation apparatus including:
a housing
a particulate inlet, adapted to ingress of said particulate matter into said housing
a fluid inlet, adapted to ingress a fluid into said housing
an outlet adapted to egress particulate matter of a predetermined density from said housing;
the method including the steps of:
ingressing particulate matter into said housing via said particulate inlet,
ingressing said fluid into said housing via said fluid inlet, and
egressing particulate matter of a predetermined density from said housing via said outlet.

14. A separation apparatus for separating particulate matter, adapted for use with a grinding or milling device, the separation apparatus including:
a housing;
a particulate inlet, adapted to ingress said particulate matter into said housing;
a fluid inlet, adapted to ingress a fluid into said housing; and
an outlet adapted to egress particulate matter of a predetermined density from said housing.

15. A separation apparatus as claimed in claim 14, wherein said fluid inlet is adapted to ingress said particulate matter in a lower portion of said housing.

16. A separation apparatus as claimed in claims 14 or 15, wherein said outlet is adapted to egress particulate matter of a predetermined density from an upper portion of said housing.

17. A separation apparatus as claimed in claims 14 or 15, wherein said outlet is adapted to egress particulate matter of a predetermined density from a lower portion of said housing.

18. A separation apparatus as claimed in claim 14 or 15, wherein said outlet is adapted to egress of particulate matter of a predetermined density from an upper portion of said housing and said apparatus further includes a second outlet which is adapted to egress particulate matter of a second predetermined density from a lower portion of said housing.

19. A separation apparatus as claimed in any of claims 14 to 18, wherein said particulate inlet includes at least one size separation screen.

20. A separation apparatus as claimed in any of claims 14 to 19, wherein the separation apparatus is sectionalized.

21. A separation apparatus as claimed in any of claims 14 to 20, wherein said apparatus housing includes at least one distribution screen adapted to aid distribution of a fluid flowing through said screen.

22. A separation apparatus as claimed in any of claims 14 to 21, wherein said apparatus includes a plurality of fluid inlets.

23. A separation apparatus as claimed in any of claims 14 to 22, wherein said fluid inlet is located below a perforated plate that extends across the housing.

24. A multi-stage separation device for separating particulate matter, including at least two separation apparatus as described in any of claims to 14 to 23, wherein said outlet of first separation apparatus is adapted to feed particulate matter to said particulate inlet of second separation apparatus.

25. A multi-stage separation device as claimed in claim 24, wherein a size separation screen is located between said outlet of first separation device and said particulate inlet of second separation device.

26. A device or apparatus as claimed in any of claims 14 to 25, wherein the device or apparatus is installed in a vertical spindle mill.

27. A method for separating particulate matter in a grinding or milling device using a separation apparatus including:
a housing
a particulate inlet, adapted to ingress of said particulate matter into said housing
a fluid inlet, adapted to ingress a fluid into said housing
an outlet adapted to egress particulate matter of a predetermined density from said housing;
the method including the steps of:
ingressing particulate matter into said housing via said particulate inlet,
ingressing a fluid into said housing via said fluid inlet, and
egressing particulate matter of a predetermined density from said housing via said outlet.
